(19) United States
(12) Patent Application Publication
(10) Pub. No.: US 2026/0140775 A1
(43) Pub. Date: May 21, 2026

(54) METHOD AND SYSTEM FOR MACHINE LEARNING OPERATIONS IN PRIVATE NETWORK ENVIRONMENT

(71) Applicant: Vessl AI Korea Inc., Gwangju (KR)

(72) Inventors: Jae Man AN, Seoul (KR); Yong Seon LEE, Seoul (KR); Ji Hwan CHUN, Seongnam-si (KR)

(73) Assignee: Vessl AI Korea Inc., Gwangju (KR)

(21) Appl. No.: 19/272,352

(22) Filed: Jul. 17, 2025

(30) Foreign Application Priority Data
Nov. 21, 2024 (KR) 10-2024-0166871

(51) Int. Cl. G06F 9/50; G06F 9/54; H04L 9/40

(52) U.S. Cl. CPC G06F 9/5027; G06F 9/547; H04L 63/0823; H04L 63/0838; H04L 63/166

(57) ABSTRACT

Disclosed is a method for machine learning operations in a private network environment, which is performed by a machine learning operations system. The method includes verifying, by the machine learning operations platform, when a user requests a machine learning job from a machine learning operations platform, the request and generating a job specification according to the request, performing, by a cluster agent, polling on the machine learning operations platform based on a preset first period to check whether a machine learning job specification is allocated from the machine learning operations platform, converting, by the cluster agent, the machine learning job specification received from the machine learning operations platform in a Kubernetes resource form, and dynamically scheduling, by a Kubernetes API server, a container resource in response to a container resource generation request received from the cluster agent.

### CROSS-REFERENCE TO RELATED APPLICATIONS

This application claims priority under 35 U.S.C. § 119 to Korean Patent Application No. 10-2024-0166871 filed on Nov. 21, 2024, in the Korean Intellectual Property Office, the disclosures of which are incorporated by reference herein in their entireties.

### BACKGROUND

Embodiments of the present disclosure described herein relate to a method and a system for machine learning operations, which support efficient resource management and log collection through the safe integration with a user computational resource in a private network environment. More particularly, embodiments of the present disclosure described herein relate to a method and a system for operating a machine learning platform, which support an on-premise environment.

With the development of machine learning (ML) and artificial intelligence (AI) technologies, solutions using the ML and AI technologies are being actively developed in various industries. The importance of a machine learning operations (MLOps) platform is increasing to efficiently manage the development, distribution, and operations of ML/AI models.

The MLOps platform provides an integrated environment which manages the entire lifecycle of the ML/AI models, including data preparation, model training, evaluation, deployment, monitoring, etc. This allows data scientists and ML engineers to focus on model development, and companies may improve the productivity and quality of ML/AI projects.

A conventional MLOps platform is mainly established in the form of a service which is provided in a cloud environment. The conventional MLOps platform thus established is advantageous in terms of scalability and flexibility but is disadvantageous in terms of data security, regulatory compliance, and network bandwidth. Accordingly, there is an increasing demand for establishing the MLOps platform in an on-premise environment.

Meanwhile, as a container orchestration platform such as Kubernetes is widely used with the development of container technologies, such a technology is also being applied to ML/AI workload management. The container-based MLOps platform provides consistency, isolation, and portability of the environment and thus makes the development and operations of ML/AI models more efficient.

The problem to be solved by the present disclosure is to provide a method and a system for operating a machine learning platform, which support an on-premise environment.

A conventional MLOps platform has limited accessibility in a private network environment. Many companies operate systems in private network environments isolated from the outside for security reasons; in this case, it is difficult to use an existing cloud-based MLOps platform. In particular, when the connection to the outside is limited due to firewalls or security policies, smooth communication between the MLOps platform and the user's computational resource becomes difficult.

Also, the training and inference of the ML/AI model requires a large computational resource, but the conventional MLOps platform has a limitation in efficiently utilizing a local computational resource of the user. In particular, the conventional MLOps platform lacks a function for allocating and optimizing resources in real time depending on a dynamically changing workload.

In addition, considering that the collection and analysis of various indicators and logs are required to monitor and improve the performance of ML/AI models, the conventional MLOps platform struggles to collect data effectively and to transfer the collected data to a centralized storage. In particular, when network disconnection occurs or when direct data transmission is impossible due to security policies, continuous monitoring and analysis become difficult.

Nowadays, the container-based ML/AI workload is increasing, but the conventional MLOps platform struggles to provide a function for managing resources finely in a container environment. In particular, the conventional MLOps platform lacks a function for efficiently allocating and monitoring a special hardware resource such as a Graphics Processing Unit (GPU).

Because conventional MLOps platforms are dependent on a specific cloud environment or an infrastructure in many cases, flexible platform establishment and operations in various environments such as on-premise, multi-cloud, and hybrid cloud are difficult. This makes the quick adaptation to the MLOps environment according to the change in the company's infrastructure strategy difficult.

Due to the above issues, it was difficult to establish and operate an efficient and safe MLOps platform in a company environment where security is important.

Accordingly, the inventor(s) of the present disclosure has come to newly develop a method and a system for machine learning operations, which are capable of solving the above limitations or difficulties and effectively utilizing the computational resource of the user.

Problems to be solved by the present disclosure are not limited to the above problems, and other problems not mentioned herein may be clearly understood from the specification and the accompanying drawings by one skilled in the art to which the present disclosure pertains.

### SUMMARY

A method for machine learning operations in a private network environment, which is performed by a machine learning operations system may include verifying, by the machine learning operations platform, when a user requests a machine learning job from a machine learning operations platform, the request and generating a job specification according to the request, performing, by a cluster agent, polling on the machine learning operations platform based on a preset first period to check whether a machine learning job specification is allocated from the machine learning operations platform, converting, by the cluster agent, the machine learning job specification received from the machine learning operations platform in a Kubernetes resource form, and dynamically scheduling, by a Kubernetes API server, a container resource in response to a container resource generation request received from the cluster agent.

The method may further include issuing, by the machine learning operations platform, a unique one-time token in response to a compute cluster registration request of the user, transferring, by the machine learning operations platform, the unique one-time token to the user, and installing, by the user, the cluster agent on a compute cluster by using the unique one-time token.

The method may further include requesting, by the cluster agent, authentication from the machine learning operations platform by using the unique one-time token, issuing, by the machine learning operations platform, a unique certificate to the cluster agent, when the authentication is successful, and performing, by the machine learning operations platform and the cluster agent, mutual transport layer security (mTLS) communication based on the unique certificate.

The method may further include, after the dynamical scheduling of the container resource, notifying, by the Kubernetes API server, the cluster agent that the container resource corresponding to the machine learning job is generated, and reporting, by the cluster agent, that the machine learning job is allocated.

The method may further include, when monitoring data are generated at a workload pod, monitoring, by a sidecar container, the monitoring data based on a preset second period, and collecting, by the sidecar container, the monitoring data so as to be stored in a temporary storage.

The method may further include collecting, by an aggregator, the monitoring data collected and stored by the sidecar container from the sidecar container based on a preset third period, compressing and placing, by the aggregator, the monitoring data collected by the aggregator, receiving, by the cluster agent, the monitoring data thus compressed and placed from the aggregator, depending on a preset fourth period or when a size of the monitoring data thus compressed and placed is larger than or equal to a preset threshold value, and transmitting, by the cluster agent, the monitoring data thus compressed and placed to the machine learning operations platform.

The method may further include receiving, by the machine learning operations platform, the monitoring data thus compressed and placed, verifying and parsing, by the machine learning operations platform, the monitoring data thus compressed and placed, storing, by the machine learning operations platform, the monitoring data thus compressed and placed in a central storage, and indexing, by the machine learning operations platform, the monitoring data thus compressed and placed.

According to an embodiment, a machine learning operations system may include a machine learning operations platform and a compute cluster. When a user requests a machine learning job, the machine learning operations platform may verify the request and may generate a job specification according to the request. The compute cluster may include a cluster agent that performs polling on the machine learning operations platform to check whether a machine learning job specification is allocated from the machine learning operations platform and converts the machine learning job specification received from the machine learning operations platform in a Kubernetes resource form, and a Kubernetes API server that dynamically schedules a container resource in response to a container resource generation request received from the cluster agent. The compute cluster may be implemented with a network which permits an outbound traffic and does not permit an inbound traffic.

According to an embodiment, a non-transitory computer-readable recording medium may store a computer program which is executed by a computer. The computer program may cause a machine learning operations platform to verify, when a user requests a machine learning job from the machine learning operations platform, the request and to generate a job specification according to the request, a cluster agent to perform polling on the machine learning operations platform based on a preset first period to check whether a machine learning job specification is allocated from the machine learning operations platforms, the cluster agent to convert the machine learning job specification received from the machine learning operations platform in a Kubernetes resource form, and a Kubernetes API server to dynamically schedule a container resource in response to a container resource generation request received from the cluster agent.

Technical solutions of the present disclosure are not limited to the above-described solutions, and solutions that are not mentioned will be clearly understood by those skilled in the art to which the present disclosure pertains from the present specification and the accompanying drawings.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings.

FIG. 1 is a conceptual diagram illustrating an architecture of a machine learning operations system according to an embodiment of the present disclosure.

FIG. 2 is a block diagram illustrating a configuration of a computing device for machine learning operations, according to an embodiment of the present disclosure.

FIG. 3 is a sequence diagram illustrating a process in which a compute cluster of a user is authenticated by using a unique one-time token, according to an embodiment of the present disclosure.

FIG. 4 is a sequence diagram illustrating a process in which a job execution command of a user is scheduled to a compute cluster, according to an embodiment of the present disclosure.

FIG. 5 is a sequence diagram illustrating a monitoring data collection process and a process in which monitoring data are transmitted to a machine learning operations platform, according to an embodiment of the present disclosure.

FIG. 6 is a flowchart illustrating a method for machine learning operations in a private network environment, according to an embodiment of the present disclosure.

### DETAILED DESCRIPTION

Specific structural or functional descriptions which are described in the specification in association with various embodiments according to the present disclosure are provided only for the purpose of describing embodiments according to the present disclosure, and the embodiments according to the present disclosure may be carried out in various different forms, not limiting the embodiments described in the specification.

Because the embodiments according to the present disclosure are susceptible to various modifications and alternative forms, the embodiments will be shown as an example in the drawings and will be described in detail in the specification. However, the embodiments according to the present disclosure include modifications, equivalents, and alternatives falling within the spirit and scope of the present disclosure, not limiting the embodiments according to the present disclosure to particular forms disclosed herein.

Even though the terms “first”, “second”, etc. may be used to describe various components, the components should not be construed as being limited by the terms. These terms are only used to distinguish one element from another. For example, a first element may be termed a second element, and, similarly, the second element may be termed the first element, without departing from the scope of the present disclosure.

It should be understood that when a first component is referred to as being “connected” or “coupled” to a second component, the first component may be directly connected or coupled to the second component or intervening components may be present therebetween. In contrast, when a component is referred to as being “directly connected” or “directly coupled” to another component, it should be understood that any other component is not interposed therebetween. Expressions used to describe relationships between components, for example, “between” versus “directly between”, “adjacent” versus “directly adjacent,” etc. should be interpreted in a like fashion.

The terms used herein are only to describe specific embodiments and are not intended to limit the present disclosure. The articles “a”, “an”, and “the” are singular in that they have a single referent, but the use of the singular form should not preclude the presence of more than one referent. In the specification, it should be understood that the terms “comprises”, “comprising”, “includes”, “including”, etc. specify that described features, numbers, steps, operations, components, or parts or a combination thereof exists, but do not preclude the presence or addition of one or more other features, numbers, steps, operations, components, or parts or a combination thereof.

Unless otherwise defined, all terms including technical and scientific terms used herein have the same meaning as commonly understood by one of ordinary skill in the art to which the present disclosure pertains. It will be further understood that terms defined in commonly used dictionaries should be interpreted as having a meaning consistent with their meaning in the context of the related art and will not be interpreted in an idealized or overly formal sense unless expressly so defined herein.

In the specification, a processor may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

In other words, the processor may refer to a functional and/or structural combination of hardware for carrying out the technical idea of the present disclosure and/or software for driving the hardware.

Below, embodiments will be described in detail with reference to the accompanying drawings. However, the scope of the patent application is neither limited nor restricted by the embodiments. The same reference numerals/signs in the drawings denote the same members.

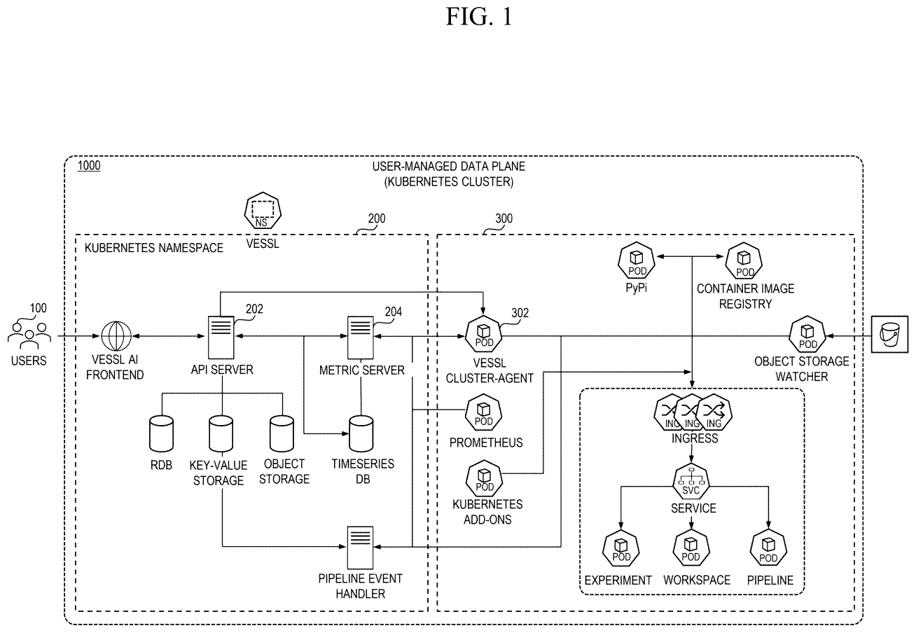

FIG. 1 is a conceptual diagram illustrating an architecture of a machine learning operations system according to an embodiment of the present disclosure.

Referring to FIG. 1, a machine learning operations system 1000 according to an embodiment of the present disclosure may include a user 100, a machine learning operations platform 200 corresponding to a control plane which the machine learning operations system 1000 manages, and/or a compute cluster 300 corresponding to a data plane which is operated on the infrastructure of the user 100.

According to an embodiment of the present disclosure, the machine learning operations platform 200 may be a machine learning operations (MLOps) platform. The machine learning operations platform 200 which is a platform for automating and managing the entire lifecycle from development to distribution and operations of a machine learning model may directly provide key functions of machine learning, services, and computational resource allocation to the user 100. The machine learning operations platform 200 may perform functions such as user authentication, machine learning job scheduling, machine learning model version management, and experiment tracking. In an embodiment, the machine learning operations platform 200 may communicate with the user 100 and the compute cluster 300 through a RESTful API.

The machine learning operations platform 200 may include an API server 202. The API server 202 may execute business logic of the machine learning operations platform 200. The API server 202 may provide an interface which directly communicates with the user 100 by using a method such as a world wide web (Web), a command line interface (CLI), and/or a software development kit (SDK). In addition to the API server 202, the machine learning operations platform 200 may further include a metric server 204 which stores and queries logs, metrics, and/or files generated from workloads, a database, etc.

In an embodiment of the present disclosure, the computational resource may be established in the form of a cluster. According to an embodiment of the present disclosure, the compute cluster 300 may be a component which the user 100 holds and is established in the private network environment. The computational resource including hardware resources, which are necessary at respective stages of the machine learning lifecycle, such as a central processing unit (CPU), a graphic processing unit (GPU), a memory, and a storage may be implemented in the compute cluster 300. The compute cluster 300 may execute the actual ML/AI workload. According to an embodiment, the compute cluster 300 may be implemented based on a container and may be managed by using the Kubernetes.

The compute cluster 300 may include a cluster agent 302. The compute cluster 300 may communicate with the machine learning operations platform 200 through the cluster agent 302.

As a key component installed in the compute cluster 300, the cluster agent 302 is a subject which manages the compute cluster 300. The cluster agent 302 may serve to communicate with the machine learning operations platform 200. The cluster agent 302 may perform functions such as machine learning job execution, status report, and computational resource monitoring. In detail, the cluster agent 302 may control and determine how to execute a machine learning job which the user 100 requests, how to report the status of machine learning jobs in the compute cluster 300 to the user 100, how to monitor an allocation present situation of the computational resource for the machine learning job, etc. According to an embodiment of the present disclosure, because most of the data necessary for machine learning includes sensitive information which should not be exposed to the outside, the compute cluster 300 is in a state of being set to use only the outbound connection. In other words, the compute cluster 300 according to an embodiment of the present disclosure may be implemented with a network in which the outbound traffic is permitted and the inbound traffic is not permitted. According to the above description, the security of the machine learning operations system 1000 according to an embodiment of the present disclosure may be reinforced. Due to the above characteristic of the compute cluster 300, the user 100 communicates only through the machine learning operations platform 200, and the cluster agent 302 operates to schedule and control the machine learning job to the computational resource in the compute cluster 300 depending on a request of the user 100.

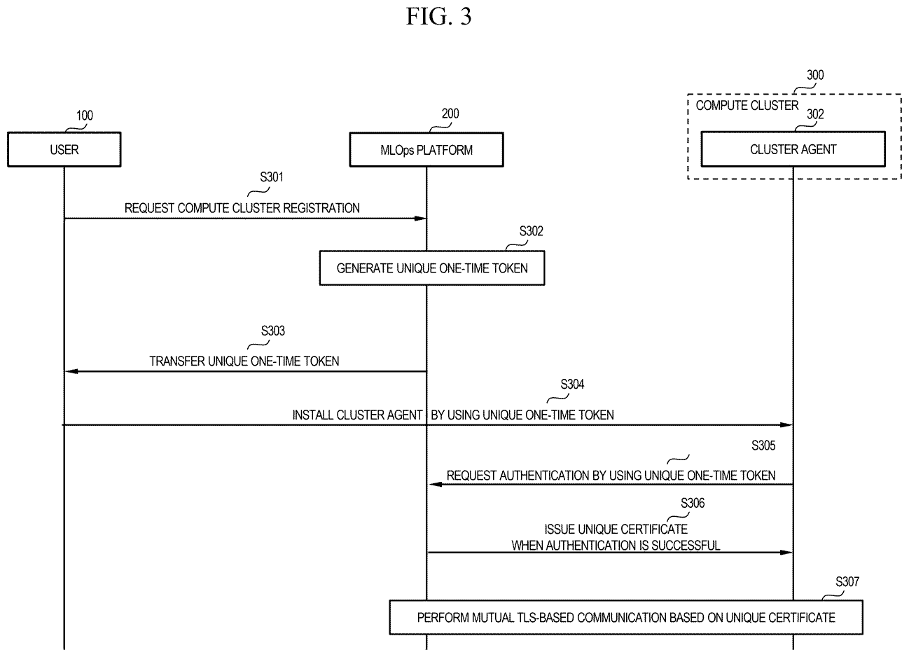

The security mechanism of the machine learning operations system 1000 according to an embodiment of the present disclosure may be implemented by encrypting all communications in the machine learning operations system 1000 through the HTTPS (Hypertext Transfer Protocol Secure), using mutual transport layer security (mTLS) communication, and verifying the validity of each request by using a token-based authentication system. This will be described with reference to FIG. 3.

The security mechanism of the machine learning operations system 1000 according to an embodiment of the present disclosure may be implemented by allowing the cluster agent 302 to periodically perform polling on the machine learning operations platform 200 to check a new machine learning job or a command from the user 100.

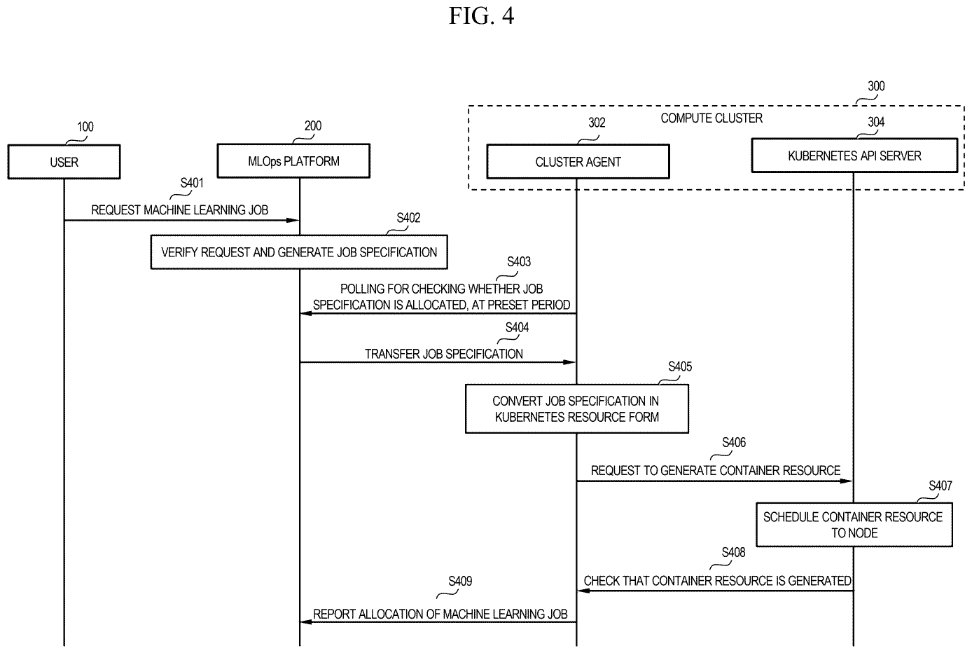

In detail, because the compute cluster 300 according to an embodiment of the present disclosure uses only the outbound connection from the internal network to the outside, it is impossible for the machine learning operations platform 200 to instruct the machine learning job directly to the compute cluster 300. In this case, according to an embodiment of the present disclosure, to perform the machine learning job with the computational resource which the user 100 holds, the cluster agent 302 included in the compute cluster 300 may perform polling on the machine learning operations platform 200 based on a preset period and may determine whether a machine learning job specification is allocated. This will be described with reference to FIG. 4.

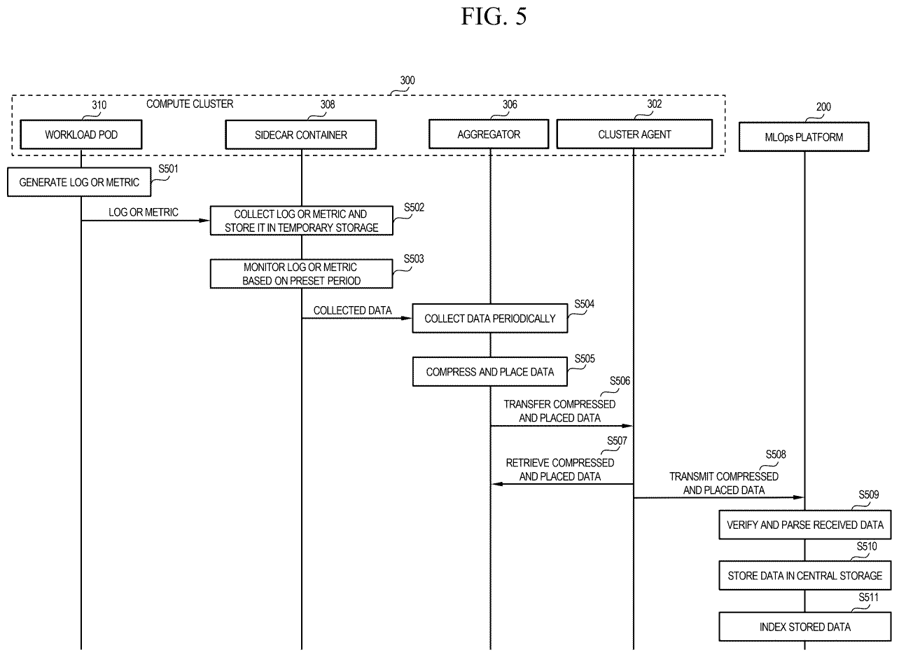

The machine learning operations system 1000 according to an embodiment of the present disclosure may dynamically allocate and monitor the computational resource. In detail, a resource manager which is installed at each node of the compute cluster 300 may monitor, in real time, usage amounts of resources such as a CPU, a memory, and a GPU. Monitoring data (e.g., logs and/or metrics) collected in the compute cluster 300 may be stored in real time through a Prometheus component and may be periodically reported to the machine learning operations platform 200. A scheduler of the machine learning operations platform 200 may perform optimal resource allocation determination, based on the monitoring data periodically reported to the machine learning operations platform 200. A sidecar container may be together distributed to each workload and may collect monitoring data including logs or metrics. After the collected monitoring data are buffered in a local temporary storage, the collected monitoring data may be compressed or placed in an aggregator so as to be transmitted to the machine learning operations platform 200. This will be described with reference to FIG. 5.

For data security and regulatory compliance, the machine learning operations system 1000 according to an embodiment of the present disclosure may support the flexible establishment of a machine learning operations platform at the cloud level even in an on-premise environment. According to the above description, the machine learning operations system 1000 according to an embodiment of the present disclosure may improve container-based ML/AI project productivity and quality through efficient allocation and monitoring of a special hardware resource such as a GPU. Also, the machine learning operations system 1000 according to an embodiment of the present disclosure may reinforce security through auto-generated one-time tokens and mutual TLS authentication and may overcome restrictions on network security policies by using only the outbound connection. In addition, the machine learning operations system 1000 according to an embodiment of the present disclosure may optimize machine learning costs through a real-time resource monitoring and dynamic allocation system in the container environment. Furthermore, the machine learning operations system 1000 according to an embodiment of the present disclosure may effectively collect various indicators and logs by utilizing the cluster agent and the sidecar container and may provide the collected indicators and logs to the user, and thus, performance or indicator monitoring and maintenance of the machine learning model may become easier.

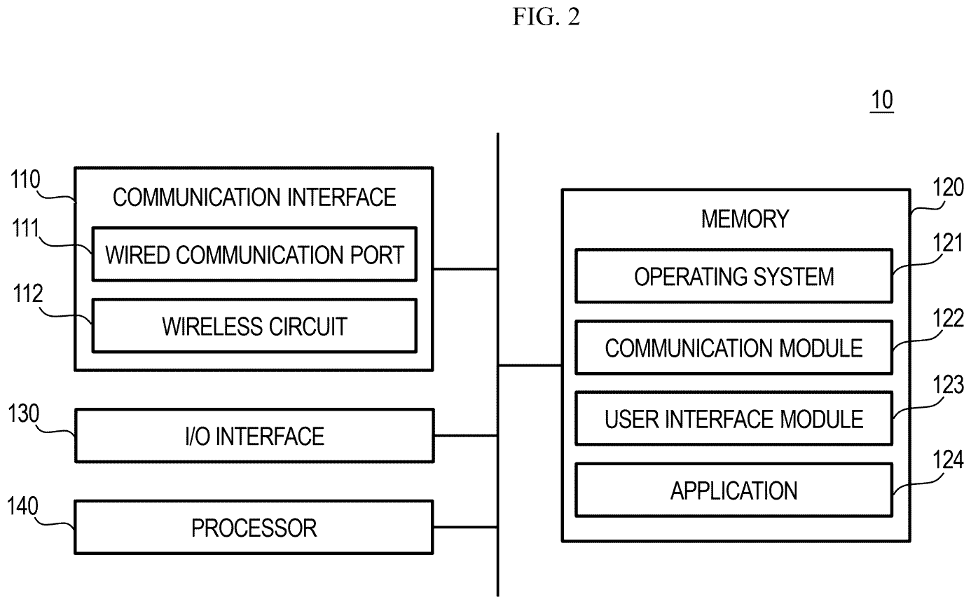

FIG. 2 is a block diagram illustrating a configuration of a computing device for machine learning operations, according to an embodiment of the present disclosure.

Referring to FIG. 2, a computing device 10 for machine learning operations may be a server which provides a machine learning operations service depending on a request of a user (or a user device) or a user device in which a web page, an application, and/or a program capable of performing machine learning operations is installed and executed.

The computing device 10 for machine learning operations may include a communication interface 110, a memory 120, an I/O interface 130, and/or a processor 140, which communicate with each other through one or more communication buses or signal lines.

The communication interface 110 may connect to a user device (not illustrated) over a wired/wireless communication network to exchange data. For example, when the computing device 10 for machine learning operations is a server, the communication interface 110 may receive a machine learning job command or a compute cluster registration request from the user device. Also, the communication interface 110 may transmit monitoring data including logs and/or metrics to the user. The monitoring data which are transmitted to the user may be data obtained by performing “compressing and placing” and indexing on logs and/or metrics.

Meanwhile, the communication interface 110 which enables the transmission/reception of data may include a wired communication port 111 and a wireless circuit 112. Herein, the wired communication port 111 may include one or more wired interfaces, for example, Ethernet, universal serial bus (USB), IEEE1394 (e.g., FireWire, Apple: i.Link, Sonny: Lynx, Texas Instrument), etc. Also, the wireless circuit 112 may transmit/receive data to/from an external device through a radio frequency (RF) signal or an optical signal. Furthermore, the wireless communication may use at least one of a plurality of communication standards, protocols, and technologies, for example, global system for mobile communications (GSM), enhanced data rates for GSM evolution (EDGE), code-division multiple access (CDMA), time division multiple access (TDMA), Bluetooth, Wi-Fi, VoIP, Wi-MAX, or any other appropriate communication protocol.

The memory 120 may store a variety of data which are used in the computing device 10 for machine learning operations. For example, the memory 120 may store logs, metrics, system metrics, and/or metadata of files, which are generated from workloads. For another example, the memory 120 may store data which the cluster agent 302 collects in the compute cluster 300 according to an embodiment of the present disclosure. Also, the memory 120 may store a collection code directly written by the user or data stored in an automatic upload directory.

In various embodiments, the memory 120 may include a volatile or nonvolatile recording medium capable of storing various kinds of data, commands, and/or information. For example, the memory 120 may include a storage medium of at least one type among the following types: a flash memory type, a hard disk type, a multimedia card micro type, a card type memory (e.g., an SD or XD memory), a random access memory (RAM), a static RAM (SRAM), a read-only memory (ROM), a programmable ROM (PROM), an electrically erasable programmable ROM (EEPROM), network storage, cloud, and a blockchain database.

In various embodiments, the memory 120 may store at least one of an operating system 121, a communication module 122, a user interface module 123, and one or more applications 124.

The operating system 121 (e.g., an embedded operating system such as LINUX, UNIX, MAC OS, WINDOWS, or VxWorks) may include various software components and drivers for controlling and managing general system jobs (e.g., memory management, storage device control, and power management) and may support communication between various hardware, firmware, and software components.

The communication module 122 may support communication with any other device through the communication interface 110. The communication module 122 may include various software components for processing data received by the wired communication port 111 or the wireless circuit 112 of the communication interface 110.

The user interface module 123 may receive a request or an input of the user from a keyboard, a touchscreen, a keyboard, a mouse, and/or a microphone through the I/O interface 130 and may provide a user interface on a display.

The application 124 may include a program or a module which is configured to be executable by one or more processors 140. Herein, an application which provides a service for processing all stages necessary for machine learning research and development, including machine learning, machine learning model distribution, monitoring, and/or computational resource scheduling, may be implemented on a server farm.

The I/O interface 130 may connect an input/output device (not illustrated) of the computing device 10 for machine learning operations, for example, at least one of a display, a keyboard, a touchscreen, and a microphone with the user interface module 123. The I/O interface 130 may receive a user input (e.g., a voice input, a keyboard input, or a touch input) together with the user interface module 123 and may process a command according to the received input.

The processor 140 may be connected to the communication interface 110, the memory 120, and the I/O interface 130 to control all operations of the computing device 10 for machine learning operations and may perform various commands for machine learning operations through the application and/or the program stored in the memory 120.

The processor 140 may correspond to a computing device such as a central processing unit (CPU) or an application processor (AP). Also, the processor 140 may be implemented in the form of an integrated chip (IC) such as a system on chip (SoC) in which various computing devices are integrated. In addition, the processor 140 may include a module for calculating an artificial neural network model such as a neural processing unit (NPU).

FIG. 3 is a sequence diagram illustrating a process in which a compute cluster of a user is authenticated by using a unique one-time token, according to an embodiment of the present disclosure.

Referring to FIG. 3, there is illustrated a process in which the user 100 installs the cluster agent 302 on the compute cluster 300 through the MLOps platform 200 and performs authentication and interworking on the compute cluster 300 by using a unique one-time token which the MLOps platform 200 generates. In FIG. 3, the MLOps platform 200 may be an example of a machine learning operations platform of FIG. 1.

For security reasons, the MLOps platform 200 needs to authenticate only the compute cluster 300 issuing an explicit command for a computational resource which the user wants to use. According to an embodiment of the present disclosure, the corresponding compute cluster 300 may be initially authenticated only once depending on the request of the user, and afterwards, the corresponding compute cluster 300 may be determined as an authenticated cluster, and the user may continuously perform communication with the corresponding compute cluster 300 through the MLOps platform 200.

Referring to FIG. 3, the user 100 may request a new compute cluster registration request from the MLOps platform 200 (S301).

In response to the request of the user, the MLOps platform 200 may generate a unique one-time token (S302) and may transfer the generated unique one-time token to the user 100 (S303).

The user 100 may install the cluster agent 302 on the compute cluster 300 of the user 100 by using the received unique one-time token. Herein, the user 100 may access the compute cluster 300 solely at an installation step S304 of the entire service operation to declare that the corresponding compute cluster 300 is a cluster dependent on the MLOps platform 200 and to transfer a relevant token to the corresponding compute cluster 300.

During initial booting, the cluster agent 302 may request authentication of the cluster agent 302 to the MLOps platform 200 by using the unique one-time token which the user 100 transfers (S305).

When the MLOps platform 200 authenticates the cluster agent 302, that is, when the cluster agent 302 succeeds in authentication, the MLOps platform 200 may issue a unique certificate to the cluster agent 302 (S306).

Mutual TLS-based communication can be performed between the MLOps platform 200 and the cluster agent 302 based on the unique certificate.

FIG. 4 is a sequence diagram illustrating a process in which a job execution command of a user is scheduled to a compute cluster, according to an embodiment of the present disclosure.

Referring to FIG. 4, there is illustrated a process in which a job execution command which the user 100 gives through the MLOps platform 200 is scheduled to the compute cluster 300 of the user. In FIG. 4, the MLOps platform 200 may be an example of a machine learning operations platform 200 of FIG. 1.

Referring to FIG. 4, the user 100 may request a machine learning job (e.g., machine learning model training) by using a web user interface (UI) or a command-line interface (CLI) (S401).

The MLOps platform 200 may verify the request received from the user 100 and may generate a job specification according to the request (S402). The generated job specification may be stored in an internal database of the MLOps platform 200.

In this case, the step of verifying the request received from the user 100 may be, for example, a step of checking whether the received request is a request to execute a process that the MLOps platform (200) can schedule, whether a computational resource for performing a corresponding job is sufficient, whether the user 100 requests a job which uses data actually accessible by the compute cluster 300, whether a command which the user 100 intends to execute is error-free, etc. The step of verifying the request received from the user 100 may be a step of performing first verification at the MLOps platform 200 for security. Because the compute cluster 300 is set to use only the outbound connection, it is impossible for the MLOps platform 200 to directly request the machine learning job, which is based on the job specification, from the cluster agent 302. The stored job specification and machine learning job request may be transferred to the compute cluster 300 through subsequent steps including step S403.

To check whether the job specification is allocated, the cluster agent 302 may perform polling on the MLOps platform 200 depending on a preset period (e.g., 15 seconds) (S403). As the cluster agent 302 performs polling periodically, the cluster agent 302 may check if there are any job specification not yet allocated on the MLOps platform 200 exists.

At polling of a specific time point, when a job specification not yet allocated exists, the MLOps platform 200 may transfer the job specification not yet allocated to the cluster agent 302 (S404).

The cluster agent 302 may analyze the transferred job specification and may convert the job specification in a Kubernetes resource form (S405). In other words, under the assumption that the corresponding job specification is a job specification already verified, the cluster agent 302 may convert the job specification in a form (e.g., a container) necessary for Kubernetes corresponding to a tool which manages a cluster. According to the above description, the cluster agent 302 may define, retrieve, and/or translate the job specification such that a Kubernetes API server 304 is capable of executing the command of the user 100 as a container.

The cluster agent 302 may generate a required resource (e.g., a workload pod or a job) through the Kubernetes API server 304.

In this case, the cluster agent 302 may request the Kubernetes API server 304 to generate a container resource (S406).

The Kubernetes API server 304 may schedule the container resource to an appropriate node in the compute cluster 300 (S407). A Kubernetes scheduler may allocate the container resource to the appropriate node in the compute cluster 300. In this case, the container resource may be allocated in the form of a Kubernetes pod. The machine learning job may be packaged to a Docker container and may be executed. A workload (e.g., a learning job or an inference service) specialized for machine learning may be defined and managed by using a custom resource definition (CRD) of the Kubernetes. As an example, a computational resource such as a GPU resource may be managed through an NVIDIA Device Plugin and may be dynamically allocated if necessary.

The Kubernetes API server 304 may determine that the container resource for the cluster agent 302 is generated (S408). For example, the Kubernetes API server 304 may transmit, to the cluster agent 302, an “Ack” message indicating that the container resource is generated.

The cluster agent 302 may report, to the MLOps platform 200, that the machine learning job which the user 100 requests is allocated (S409).

According to an embodiment of the present disclosure, because the user 100 fails to directly transfer the job command to the compute cluster 300, the user 100 may give the job command to the compute cluster 300 through an interface such as the MLOps platform 200; in this case, the command which the user 100 gives to the MLOps platform 200 may be transferred to the compute cluster 300 through the above process.

FIG. 5 is a sequence diagram illustrating a monitoring data collection process and a process in which monitoring data are transmitted to a machine learning operations platform, according to an embodiment of the present disclosure.

The compute cluster 300 may include a workload pod 310, a sidecar container 308, an aggregator 306, and the cluster agent 302.

In the specification, monitoring data may include logs (log data) and/or metrics (metric data). The log may include an indicator representing a machine learning process in a graph form, an indicator indicating where the workload is actually allocated or scheduled, a time required for machine learning, a characteristic or a type of output data of machine learning data, etc. The metrics may be indicators (e.g., loss and accuracy) expressed as Scalar over time while machine learning is in progress.

According to an embodiment of the present disclosure, the monitoring data generated at the workload pod 310 are not transmitted to the MLOps platform 200 in real time. That is, according to an embodiment of the present disclosure, in consideration of the burden of the machine learning operations service on the network, the monitoring data generated at the workload pod 310 are collected and stored and are then periodically transmitted to the MLOps platform 200.

Referring to FIG. 5, the workload pod 310 may generate logs or metrics (S501). The workload pod 310 may be a learning process generated by a user's request. The sidecar container 308 for log or metric collection may be distributed to the workload pod 310 together with an application container.

The sidecar container 308 may collect logs or metrics and may store the collected logs or metrics in a local temporary storage (e.g., emptyDir volume) (S502). The logs or metrics stored in the sidecar container 308, that is, the monitoring data, should be finally transmitted to the MLOps platform 200.

The sidecar container 308 may continuously monitor the logs or metrics of the application container based on a preset period (S503).

The aggregator 306 may periodically collect data collected from the sidecar container 308, that is, the monitoring data (S504). The aggregator 306 may be referred to as a “central collector” present in the compute cluster 300.

The aggregator 306 may compress and place the collected monitoring data (S505). The aggregator 306 may collect logs or metrics collected from a plurality of sidecar containers including the sidecar container 308 and may compress the collected logs or metrics in one place. The aggregator 306 may prepare efficient transmission by compressing and placing the collected monitoring data.

The aggregator 306 may transfer the compressed and placed monitoring data to the cluster agent 302 (S506). The aggregator 306 may retrieve the compressed and placed monitoring data (S507).

The cluster agent 302 may transmit the compressed and placed monitoring data to the MLOps platform 200 (S508). In an embodiment, the cluster agent 302 may fetch the compressed and placed monitoring data from the aggregator 306 based on a preset period and may then transmit the compressed and placed monitoring data thus fetched to the MLOps platform 200. In another embodiment, when the size of the compressed and placed monitoring data is larger than or equal to a preset threshold, the cluster agent 302 may fetch the compressed and placed monitoring data from the aggregator 306 and may transmit the compressed and placed monitoring data thus fetched to the MLOps platform 200.

The MLOps platform 200 or a log manager (not illustrated) of the MLOps platform 200 may verify and parse the received monitoring data (S509).

The MLOps platform 200 or the log manager of the MLOps platform 200 may store the verified and parsed monitoring data in a central storage (S510).

The MLOps platform 200 may index the monitoring data stored in the central storage (S511). The MLOps platform 200 may perform indexing on the monitoring data stored in the central storage such that the monitoring data are capable of being quickly retrieved and analyzed.

When communication between the MLOps platform 200 and the compute cluster 300 or communication between the MLOps platform 200 and the cluster agent 302 is impossible (e.g., network disconnection), the cluster agent 302 may prevent data loss through a retry mechanism. In detail, the aggregator 306 may initiate the retry mechanism, and the cluster agent 302 may receive the monitoring data from the aggregator 306.

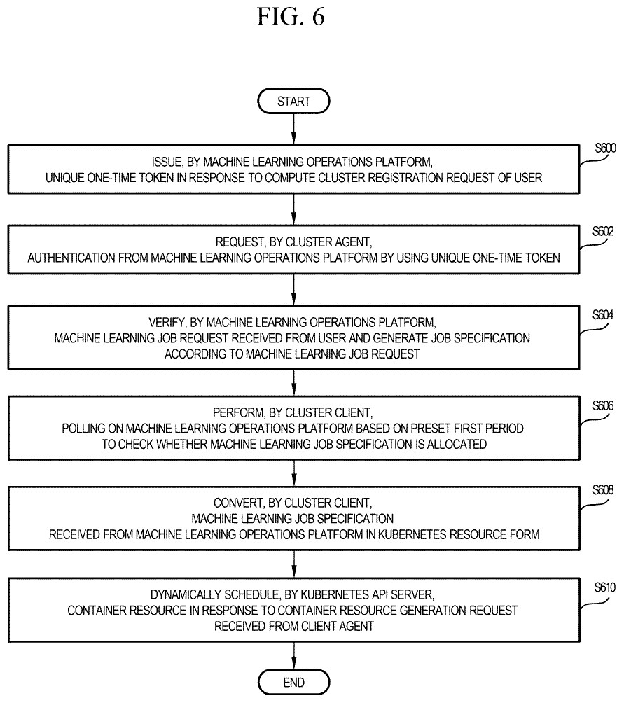

FIG. 6 is a flowchart illustrating a method for machine learning operations in a private network environment, according to an embodiment of the present disclosure.

According to a method for machine learning operations in a private network environment according to an embodiment of the present disclosure, the machine learning operations platform may issue a unique one-time token in response to a compute cluster registration request of a user (S600).

After step S600 where the unique one-time token is issued, the machine learning operations platform may transfer the unique one-time token to the user. Then, the user may install the cluster agent on a compute cluster by using the unique one-time token.

According to the method for machine learning operations in the private network environment according to an embodiment of the present disclosure, the cluster agent may request authentication from the machine learning operations platform by using the unique one-time token (S602).

At step S602 where the authentication using the unique one-time token is requested to the machine learning operations platform, when the authentication is successful, the machine learning operations platform may issue a unique certificate to the cluster agent. Afterwards, the machine learning operations platform and the cluster agent may perform mutual transport layer security (mTLS) communication based on the unique certificate.

According to the method for machine learning operations in the private network environment according to an embodiment of the present disclosure, when the user requests a machine learning job from the machine learning operations platform, the machine learning operations platform may verify the received machine learning operations request and may generate a job specification according to the machine learning operations request (S604).

According to the method for machine learning operations in the private network environment according to an embodiment of the present disclosure, to check whether the machine learning job specification is assigned, the cluster agent may perform polling on the machine learning operations platform based on a preset first period (S606).

According to the method for machine learning operations in the private network environment according to an embodiment of the present disclosure, the cluster agent may convert the machine learning job specification received from the machine learning operations platform in a Kubernetes resource form (S608).

According to the method for machine learning operations in the private network environment according to an embodiment of the present disclosure, a Kubernetes API server may dynamically schedule a container resource in response to a container resource generation request received from the cluster agent (S610).

After step S610 where the container resource is dynamically scheduled, the Kubernetes API server may notify the cluster agent that the container resource corresponding to the machine learning job is generated, to the cluster agent. Afterwards, the cluster agent may report that the machine learning job is allocated.

In an embodiment, when monitoring data are generated at a workload pod, a sidecar container may monitor the monitoring data based on a preset second period. Also, the sidecar container may collect the monitoring data and may store the collected monitoring data in a temporary storage. Afterwards, an aggregator may collect the monitoring data collected and stored by the sidecar container from the sidecar container based on a preset third period. Next, the aggregator may compress and place the monitoring data collected by the aggregator.

The machine learning operations platform may receive the compressed and placed monitoring data. In addition, the machine learning operations platform may verify and parse the monitoring data thus compressed and placed. Then, the machine learning operations platform may store the compressed and placed monitoring data in a central storage. Afterwards, the machine learning operations platform may index the monitoring data thus compressed and placed.

The machine learning operations system according to an embodiment may include a machine learning operations platform configured to issue a unique one-time token in response to a compute cluster registration request of the user, to verify a received machine learning job request when the machine learning job request is received from the user, and to generate a job specification according to the machine learning jot request, and a compute cluster.

The compute cluster may include a cluster agent configured to request authentication from the machine learning operations platform by using the unique one-time token, to perform polling on the machine learning operations platform based on a preset first period to determine whether the machine learning job specification is allocated, and to convert the machine learning job specification received from the machine learning operations platform in a Kubernetes resource form, and a Kubernetes API server configured to dynamically schedule a container resource in response to a container resource generation request received from the cluster agent.

The compute cluster may be implemented with a network which permits the outbound traffic and does not permit the inbound traffic.

The machine learning operations system according to an embodiment may include a computer program which is stored in a computer-readable recording medium coupled to a computer or a computing device, which is hardware, and performs step S600 to step S610 of FIG. 6 described above.

The machine learning operations system according to an embodiment may be implemented with a computing device including at least one processor which executes instructions of programs loaded to a memory. A program including the instructions described to execute step S600 to step S610 of FIG. 6 described above may be loaded to the memory of the computing device.

The foregoing devices may be implemented by a hardware component, a software component, and/or a combination of a hardware component and a software component. For example, the devices and the components described in the embodiments may be implemented by using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor, or any device which may execute instructions and may respond thereto. A processing unit may execute an operating system (OS) or one or more software applications running on the operating system. Also, the processing unit may access, store, manipulate, process, and generate data in response to the execution of software. For convenience of understanding, the description is given as a single processing unit, but it will be understood by one skilled in the art that the processing unit may include a plurality of processing elements and/or a plurality of types of processing elements. For example, the processing device may include a plurality of processors or may include one processor and one controller. Also, any other processing configuration such as a parallel processor is possible.

Software may include a computer program, a code, an instruction, or one or more combinations thereof and may constitute a processing device to operate in a desired manner or may control the processing device independently or collectively. Software and/or data may be permanently or temporarily embodied in any type of a machine, a component, physical equipment, virtual equipment, a computer storage medium, a computer device or in a transmitted signal wave, so as to be interpreted by the processing unit or to provide instructions or data to the processing unit. Software may be distributed on computer systems connected over a network so as to be stored therein or executed thereon. Software and data may be recorded in one or more computer-readable storage media.

The method according to the embodiment may be recorded in a computer-readable medium including a program instruction executable through various computer devices. The computer-readable medium may also include a program instruction, a data file, a data structure, or a combination thereof. The program instruction recorded in the medium may be designed and configured specially for the embodiment or may be known and available to one skilled in computer software. The computer-readable storage medium may include, for example, a hardware device, which is specially configured to store and execute a program instruction, such as a magnetic medium (e.g., a hard disk drive, a floppy disk or a magnetic tape), an optical medium (e.g., CD-ROM or DVD), a magneto-optical medium (e.g., a floptical disk), a read only memory (ROM), a random access memory (RAM), or a flash memory. As an example, the program instruction includes not only a machine language code created by a compiler but also a high-level language code capable of being executed by a computer by using an interpreter or the like. The hardware device may be configured to act as one or more software modules to perform the operation of the embodiment, and vice versa.

According to embodiments, it may be possible to flexibly establish a cloud-level MLOps platform even in an on-premise environment for data security and regulatory compliance, and thus, container-based ML/AI project productivity and quality may be improved through efficient allocation and monitoring of a special hardware resource such as a GPU.

According to embodiments, security may be enhanced through an auto-generated one-time token and mutual TLS authentication, and network security policy constraints may be overcome by using only the outbound connection.

According to embodiments, machine learning costs may be optimized through a real-time resource monitoring and dynamic allocation system in a container environment.

According to embodiments, by utilizing a cluster agent and a sidecar container, it may be possible to effectively collect various indicators and logs and to transmit the collected indicators and logs to a user, and thus, performance or indicator monitoring and maintenance of a machine learning model may become easier.

Effects according to the present disclosure are not limited to the above effects, and effects not mentioned herein may be clearly understood from the specification and the accompanying drawings by one skilled in the art to which the present disclosure pertains.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents to the claims fall within the scope of the following claims.

What is claimed is:

1. A method for machine learning operations in a private network environment, which is performed by a machine learning operations system, the method comprising:
when a user requests a machine learning job from a machine learning operations platform, verifying, by the machine learning operations platform, the request and generating a job specification according to the request;
performing, by a cluster agent, polling on the machine learning operations platform based on a preset first period to check whether a machine learning job specification is allocated from the machine learning operations platform;
converting, by the cluster agent, the machine learning job specification received from the machine learning operations platform in a Kubernetes resource form; and
dynamically scheduling, by a Kubernetes API server, a container resource in response to a container resource generation request received from the cluster agent.

2. The method of claim 1, further comprising:
issuing, by the machine learning operations platform, a unique one-time token in response to a compute cluster registration request of the user;
transferring, by the machine learning operations platform, the unique one-time token to the user; and
installing, by the user, the cluster agent on a compute cluster by using the unique one-time token.

3. The method of claim 1, further comprising:
requesting, by the cluster agent, authentication from the machine learning operations platform by using the unique one-time token;
when the authentication is successful, issuing, by the machine learning operations platform, a unique certificate to the cluster agent; and
performing, by the machine learning operations platform and the cluster agent, mutual transport layer security (mTLS) communication based on the unique certificate.

4. The method of claim 1, further comprising:
after the dynamical scheduling of the container resource,
notifying, by the Kubernetes API server, the cluster agent that the container resource corresponding to the machine learning job is generated; and
reporting, by the cluster agent, that the machine learning job is allocated.

5. The method of claim 1, further comprising:
when monitoring data are generated at a workload pod, monitoring, by a sidecar container, the monitoring data based on a preset second period; and
collecting, by the sidecar container, the monitoring data so as to be stored in a temporary storage.

6. The method of claim 5, further comprising:
collecting, by an aggregator, the monitoring data collected and stored by the sidecar container from the sidecar container based on a preset third period;
compressing and placing, by the aggregator, the monitoring data collected by the aggregator;
depending on a preset fourth period or when a size of the monitoring data thus compressed and placed is larger than or equal to a preset threshold value, receiving, by the cluster agent, the monitoring data thus compressed and placed from the aggregator; and
transmitting, by the cluster agent, the monitoring data thus compressed and placed to the machine learning operations platform.

7. The method of claim 6, further comprising:
receiving, by the machine learning operations platform, the monitoring data thus compressed and placed;
verifying and parsing, by the machine learning operations platform, the monitoring data thus compressed and placed;
storing, by the machine learning operations platform, the monitoring data thus compressed and placed in a central storage; and
indexing, by the machine learning operations platform, the monitoring data thus compressed and placed.

8. A machine learning operations system comprising:
a machine learning operations platform, wherein, when a user requests a machine learning job, the machine learning operations platform is configured to verify the request and to generate a job specification according to the request; and
a compute cluster,
wherein the compute cluster includes:
a cluster agent configured to perform polling on the machine learning operations platform to check whether a machine learning job specification is allocated from the machine learning operations platform and to convert the machine learning job specification received from the machine learning operations platform in a Kubernetes resource form; and
a Kubernetes API server configured to dynamically schedule a container resource in response to a container resource generation request received from the cluster agent, and
wherein the compute cluster is implemented with a network which permits an outbound traffic and does not permit an inbound traffic.

9. A non-transitory computer-readable recording medium storing a computer program, wherein the computer program, which is executed by a computer, causes:
a machine learning operations platform to verify, when a user requests a machine learning job from the machine learning operations platform, the request and to generate a job specification according to the request;
a cluster agent to perform polling on the machine learning operations platform based on a preset first period to check whether a machine learning job specification is allocated from the machine learning operations platforms;
the cluster agent to convert the machine learning job specification received from the machine learning operations platform in a Kubernetes resource form; and
a Kubernetes API server to dynamically schedule a container resource in response to a container resource generation request received from the cluster agent.
